(19) United States
(12) Patent Application Publication
(10) Pub. No.: US 2024/0234799 A1
(43) Pub. Date: Jul. 11, 2024

(54) COMPOSITE SOLID ELECTROLYTE AND SOLID-STATE BATTERY

(71) Applicants: TOYOTA JIDOSHA KABUSHIKI KAISHA, Toyota-shi (JP); OSAKA UNIVERSITY, Osaka (JP)

(72) Inventors: Shinya SHIOTANI, Nagoya-shi (JP); Yu KATAYAMA, Suita-shi (JP)

(73) Assignees: TOYOTA JIDOSHA KABUSHIKI KAISHA, Toyota-shi (JP); OSAKA UNIVERSITY, Osaka (JP)

(21) Appl. No.: 18/390,090

(22) Filed: Dec. 20, 2023

(30) Foreign Application Priority Data
Dec. 23, 2022 (JP) 2022-207656

(51) Int. Cl. H01M 10/0562

(52) U.S. Cl. CPC H01M 10/0562; H01M 2300/0068; H01M 2300/0082

(57) ABSTRACT

A composite solid electrolyte including: a polymer electrolyte containing a lithium imide salt and a polymer having an alkyl side chain that has 4 or more carbon atoms.

### CROSS-REFERENCE TO RELATED APPLICATIONS

This application claims priority under 35 USC 119 from Japanese Patent Application No. 2022-207656 filed on Dec. 23, 2022, the disclosure of which is incorporated by reference herein in its entirety.

### BACKGROUND

### Technical Field

The present disclosure relates to a composite solid electrolyte and a solid-state battery.

### Related Art

In recent years, secondary batteries such as lithium ion secondary batteries and the like have been suitably used as portable power sources of personal computers, portable terminals and the like, and power sources for the driving of vehicles such as electric vehicles (EVs), hybrid vehicles (HVs), plug-in hybrid vehicles (PHVs) and the like.

Because an electrolyte liquid containing a flammable inorganic solvent is used in a secondary battery, there is the need for improvements in structures and materials for preventing short-circuiting and for attaching safety devices that suppress a rise in temperature at the time of short-circuiting. In contrast, a solid-state battery, in which an electrolyte liquid is replaced with a solid electrolyte layer and solid materials are utilized, does not use a flammable organic solvent within the battery. Therefore, it is thought that, with solid-state batteries, simplification of safety devices can be devised, and the batteries have excellent production costs and mass producibility.

In the field of solid-state batteries, a method is known of keeping the resistance of a solid-state battery low by using a composite solid electrolyte that contains a sulfide solid electrolyte and a polymer electrolyte (for example, International Publication No. 2013/001623).

### SUMMARY

However, in conventional composite solid electrolytes, at the time of storage, the sulfide solid electrolyte and the polymer that is contained in the polymer electrolyte react at the contacting surfaces of the sulfide solid electrolyte and the polymer, and reaction products are generated. The ion conduction paths are obstructed thereby, and there is the tendency for the resistance of the battery to increase. This phenomenon is marked in long-term storage at high temperatures (e.g., 30 days at 60° C.). Aforementioned International Publication No. 2013/001623 attempts to suppress the increase in resistance by using a solid electrolyte that contains a branched polymer and a sulfide solid electrolyte that substantially does not have cross-linked sulfur. As described above, various types of research have been carried out in order to suppress resistance increasing when using the composite solid electrolyte layer, but further technological developments are desirable. Thus, in view of the above-described circumstances, an object of the present disclosure is to provide a composite solid electrolyte and a solid-state battery at which an increase in electrical resistance is suppressed.

Means for achieving the above-described object include the following means.

<1> A composite solid electrolyte including: a sulfide solid electrolyte; and a polymer electrolyte containing a lithium imide salt and a polymer having an alkyl side chain that has 4 or more carbon atoms.

<2> The composite solid electrolyte of <1>, wherein the number of carbon atoms in the alkyl side chain of the polymer is 6 or more and 8 or less.

<3> The composite solid electrolyte of <1> or <2>, wherein a mol ratio (polymer/lithium imide salt) of the polymer with respect to the lithium imide salt is 4 or more and 7 or less.

<4> The composite solid electrolyte of any one of <1> through <3>, wherein the polymer contains a compound expressed by the following general formula (1):

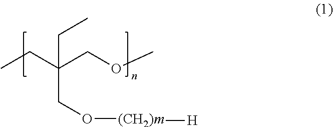

wherein, in the above general formula (1), m represents an integer of 4 or more, and n represents an integer of 1 or more.

<5> A solid-state battery including the composite solid electrolyte of any one of <1> through <4>.

In accordance with the present disclosure, there are provided a composite solid electrolyte and a solid-state battery at which an increase in electrical resistance is suppressed.

### DETAILED DESCRIPTION

Embodiments that are examples of the present disclosure are described hereinafter. The description thereof and the Examples exemplify embodiments, and are not intended to limit the scope of the invention.

### <Composite Solid Electrolyte>

The composite solid electrolyte relating to the present disclosure is a composite solid electrolyte containing a sulfide solid electrolyte, and a polymer electrolyte containing a lithium imide salt and a polymer having an alkyl side chain that has 4 or more carbon atoms. In accordance with the present disclosure, the polymer that is contained in the polymer electrolyte has an alkyl side chain that has 4 or more carbon atoms. Therefore, the alkyl side chain of this polymer suppresses the interaction between the sulfide solid electrolyte and the main chain of the polymer within the polymer electrolyte. As a result, during storage as well (e.g., 30 days at 60° C.), the sulfide solid electrolyte and the polymer reacting, and reaction products being generated, at the contacting surfaces of the sulfide solid electrolyte and the polymer are suppressed. As a result, the ion conduction paths are not obstructed by such reaction products, and the resistance can be kept low. Namely, an increase in resistance is suppressed.

### [Polymer Electrolyte]

The polymer electrolyte contains a polymer and a lithium imide salt.

The polymer is not particularly limited provided that it is a polymer that has an alkyl side chain that has 4 or more carbon atoms and that it can dissociate the lithium imide salt. One type of polymer electrolyte may be used alone, or two or more types may be used in combination.

It is preferable that the polymer be a polymer having a polar group in the main chain, and examples thereof are: nitrile polymers such as polyacrylonitrile and the like; ether polymers; ester polymers; carbonate polymers such as polycarbonate and the like; amide polymers; glycans; and the like. Thereamong, ether polymers are preferable as the type of polymer from the standpoint of suppressing an increase in resistance even more.

Nitrile polymers mean polymers containing a structural unit derived from a nitrile group. Ether polymers mean polymers containing a structural unit having an ether bond. Ester polymers mean polymers containing a structural unit derived from an ester group. Carbonate polymers mean polymers containing a structural unit derived from a carbonate group. Amide polymers mean polymers containing a structural unit derived from an amide group.

The polymer has an alkyl side chain that has 4 or more carbon atoms, and from the standpoint of suppressing an increase in resistance even more, the alkyl side chain that has preferably 4 or more and 12 or less carbon atoms, and is more preferably 5 or more and 10 or less, and it is even more preferable that the polymer have an alkyl side chain that has 6 or more and 8 or less carbon atoms.

The polymer preferably contains a compound expressed by the following general formula.

If the polymer contains a compound expressed by following general formula (1), it is even easier to suppress the generation of reaction products of the polymer within the polymer electrolyte and the sulfide solid electrolyte at the contacting surfaces of the both, and the ion conduction paths being obstructed, and the resistance increasing.

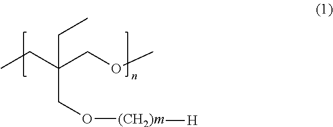

In general formula (1), n represents an integer of 1 or more.

In general formula (1), m represents an integer of 4 or more, and, from the standpoint of suppressing an increase in the resistance even more, is preferably 4 or more and 12 or less, and more preferably 5 or more and 10 or less, and even more preferably 6 or more and 8 or less.

Examples of compounds expressed by general formula (1) are given hereinafter, but the present disclosure is not limited to these examples.

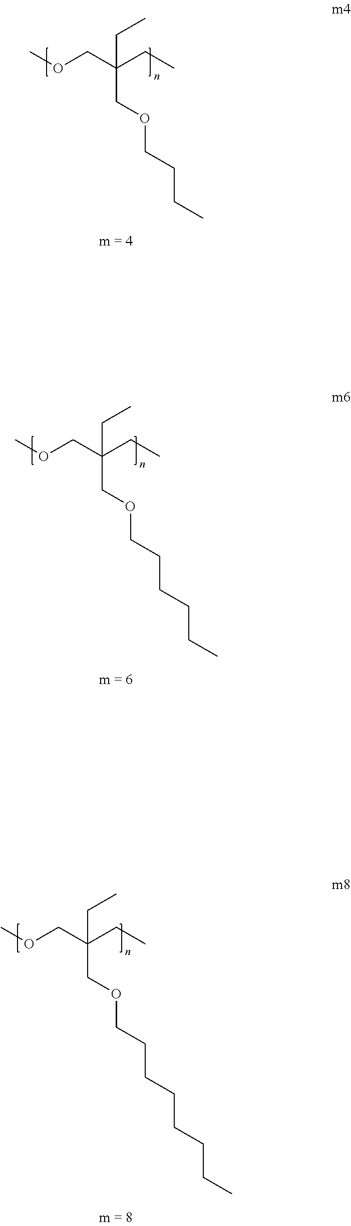

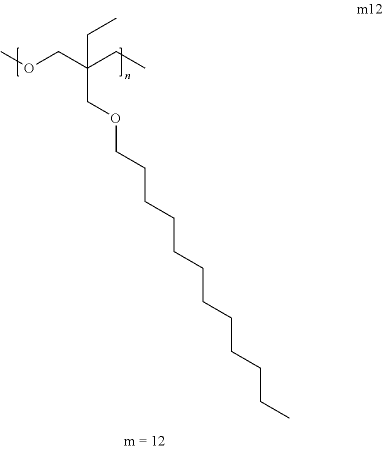

The polystyrene conversion weight average molecular weight (Mw) that is determined by gel permeation chromatography (GPC) of the polymer is not particularly limited, and, for example, may be 10,000-300,000, or may be 15,000-250,000.

From the standpoint of suppressing an increase in the resistance even more, the mol ratio of the polymer with respect to the lithium imide salt (polymer/lithium imide salt) is preferably 2 or more, and more preferably 3 or more and 8 or less, and even more preferably 4 or more and 7 or less.

Examples of the lithium imide salt are LiN(Rf₁SO₂)₂, LiN(FSO₂)₂, LiN(Rf₁SO₂)(Rf₂SO₂), lithium bis(pentafluoroethanesulfonyl)imide (LiBETI), lithium bis(trifluoromethanesulfonyl)imide (LiTFSI) and the like. Thereamong, from the standpoint of battery performance, it is preferable that the lithium imide salt contain LiTFSI. A single type of lithium imide salt may be used alone, or two or more types may be used in combination.

### [Sulfide Solid Electrolyte]

The sulfide solid electrolyte preferably contains sulfur (S) as the main component that is an anion element, and further, preferably contains, for example, the element Li, element A and the element S.

Element A is at least one type selected from the group consisting of P, As, Sb, Si, Ge, Sn, B, Al, Ga and In.

The sulfide solid electrolyte may further contain at least one of O and a halogen element.

Examples of the halogen element (X) are F, Cl, Br, I and the like. The composition of the sulfide solid electrolyte is not particularly limited, and examples are xLi₂S·(100−x)P₂S₅ (70≤x≤80) and yLiI·zLiBr·(100−y−z)(xLi₂S·(1−x)P₂S₅) (0.7≤x≤0.8, 0≤y≤30, 0≤z≤30). The sulfide solid electrolyte may have the composition expressed by following general formula (1).

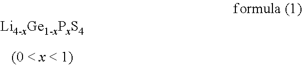

In formula (1), at least some of the Ge may be substituted by at least one selected from the group consisting of Sb, Si, Sn, B, Al, Ga, In, Ti, Zr, V and Nb. Further, at least some of the P may be substituted by at least one selected from the group consisting of Sb, Si, Sn, B, Al, Ga, In, Ti, Zr, V and Nb. Some of the Li may be substituted by at least one selected from the group consisting of Na, K, Mg, Ca and Zn. Some of the S may be substituted by a halogen. The halogen is at least one of F, Cl, Br and I.

A single type of sulfide solid electrolyte may be used alone, or two or more types may be used in combination.

From the standpoint of battery performance, for example, it is preferable that the sulfide solid electrolyte is an Li₂S—P₂S₅ sulfide solid electrolyte. If the sulfide solid electrolyte is an Li₂S—P₂S₅ sulfide solid electrolyte, reaction products of the polymer within the polymer electrolyte and the sulfide solid electrolyte are generated at the contacting surfaces of the both, and the ion conduction paths are obstructed, and it is easy for the resistance to increase. However, if the structure of the composite solid electrolyte of the present disclosure is used, an increase in resistance is suppressed in this case as well.

### [Other Components]

The composite solid electrolyte of the present disclosure may, as needed, further contain other components that are other than a sulfide solid electrolyte and a polymer electrolyte that contains a polymer and a lithium imide salt, within a scope that does not deteriorate the effects of the present disclosure. Examples of the other components are oxide solid electrolytes, halide solid electrolytes, binders (e.g., rubber binders, fluoride binders and the like), conduction assistants (fibrous carbon materials and the like), and the like.

### [Method of Fabricating Composite Solid Electrolyte]

The method of fabricating the composite solid electrolyte of the present disclosure is not particularly limited, and a known method of fabricating a solid electrolyte can be used. Examples are a method of mixing a polymer electrolyte and a solid electrolyte material together in a solvent so as to prepare a slurry, coating the slurry on a substrate, and thereafter, drying the solvent and forming a composite solid electrolyte layer; a method of joining a polymer electrolyte layer and a sulfide solid electrolyte layer that have been fabricated separately, so as to form a composite solid electrolyte layer; and the like.

### <Solid-State Battery>

The solid-state battery of the present disclosure contains the composite solid electrolyte of the present disclosure. For example, the solid-state battery of the present disclosure has a positive electrode layer, a negative electrode layer, and a solid electrolyte layer disposed between the positive electrode layer and the negative electrode layer. The solid electrolyte layer contains the composite solid electrolyte of the present disclosure. Note that the composite solid electrolyte may contain an electrolyte liquid in an amount of less than 10 mass % of the entire amount of the electrolyte.

Even in a solid-state battery having an electrode that contains an active material that easily expands and contracts (e.g., a negative electrode, and more specifically, a negative electrode containing silicon), in the composite solid electrolyte of the present disclosure, the sulfide solid electrolyte and the polymer within the polymer electrolyte reacting due to friction or the like in the solid electrolyte layer accompanying expansion/contraction of the electrode before and after storage, and the resistance increasing, are suppressed.

The solid-state battery of the present disclosure is a solid-state lithium ion secondary battery. The solid-state battery can be used, for example, as the power source of a vehicle, electronic equipment, electrical storage devices, and the like. Examples of vehicles are electric four-wheel vehicles, electric two-wheel vehicles, gasoline-powered vehicles, diesel-powered vehicles and the like. Examples of electric four-wheel vehicles are electric vehicles (BEVs), plug-in hybrid electric vehicles (PHEVs), hybrid vehicles (BEVs), and the like. Examples of electric two-wheel vehicles are electric motorbikes, electrically assisted bicycles and the like. Examples of electronic equipment are handheld devices (e.g., smartphones, tablet computers, audio players and the like), portable devices (notebook computers, CD (compact disc) players, and the like), mobile equipment (e.g., power tools, commercial video cameras, and the like), and the like. Thereamong, the solid-state battery of the present disclosure is preferably used as a power source for the driving of hybrid vehicles, plug-in hybrid vehicles, and electric vehicles.

### EXAMPLES

### Example 1

### (Preparation of Sulfide Solid Electrolyte)

An Li₂S—P₂S₅ glass ceramic containing LiI was prepared by ball-mill mixing and firing.

### (Preparation of Polymer Electrolyte Solution)

Using a base, 3-ethyl-3-hydroxymethyl oxetane was made to Williamson ether react with an alkyl compound that has 4 carbon atoms in which a leaving group was modified, and an oxetane derivative having an alkyl side chain that has 4 carbon atoms was thereby synthesized.

Using this oxetane derivative as a monomer, cationic ring-opening polymerization was carried out by using boron trifluoride diethyl ether complex as a catalyst, and a polymer having an alkyl side chain that has 4 carbon atoms was obtained (polyoxetane resin, which is a compound expressed by general formula (1) and is above compound m4). The weight average molecular weight obtained by the above-described measuring method was 47.5 kg/mol.

The obtained polymer and LiTFSI were dissolved in acetonitrile, and a polymer electrolyte in which the mol ratio of the polymer and LiTFSI (polymer:LiTFSI) was 5:1 was prepared.

### (Preparation of Polymer Electrolyte Film)

The polymer electrolyte solution was cast on an Al foil, and was coated on the Al foil by a blade method by using an applicator. The electrode was dried for 1 hour on a hot plate of 130°, and thereafter, was dried for 6 hours at 130° in a vacuum atmosphere. A polymer electrolyte film was thereby obtained.

### (Fabrication of Composite Solid Electrolyte)

A composite solid electrolyte film was obtained by affixing the sulfide solid electrolyte film and the polymer electrolyte film together.

### Examples 2-3, Comparative Examples 1-2

In preparing the polymer electrolyte solution, the alkyl compound that has 4 carbon atoms in which the leaving group was modified in Example 1 was replaced with an alkyl compound that has 1, 2, 6 or 8 carbon atoms in which the leaving group was modified. Due thereto, polymer electrolytes having an alkyl side chain that has shown in Table 1 (polyoxetane resins, which are compounds expressed by general formula (1) and are above compounds m6, m8 and following compounds m1, m2) were obtained. Thereafter, composite solid electrolytes of the respective examples were obtained in accordance with the same specifications as in Example 1. The values of the weight average molecular weights of the respective polymer electrolytes were as follows.
m1: 147.0 kg/mol
m2: 48.4 kg/mol
m6: 172.7 kg/mol
m8: 135.1 kg/mol

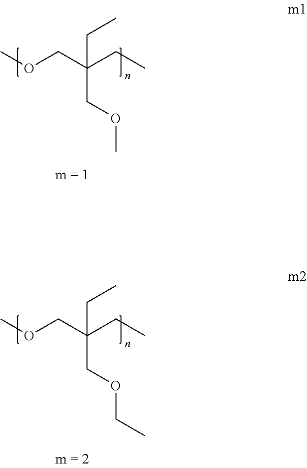

### <Evaluation of Rate of Maintaining Conductivity Before and After High-Temperature Storage>

### (Calculation of Resistance Value Before High-Temperature Storage)

A composite solid electrolyte film of each of the examples was punched to Φ11.28 within a glove box of a dew point of −80° C., Al tabs were placed on both ends, vacuum laminating was carried out, and respective cells for evaluation were thereby obtained. The cells for evaluation of the respective examples were restrained at a restraining pressure of 1 MPa, and were soaked for 3 hours at 60° C. After soaking, the resistance value was determined by an AC impedance method. In the measuring, Solartron 1260 was used, and the applied voltage was 10 mV, the measurement frequency range was 0.1 Hz-1 MHz, and the measurement temperature was 25° C. Curve fitting was carried out with respect to the arc-shaped components of the obtained impedance spectrum, and the high resistance side of the point of intersection with the real axis was used as the reaction resistance.

(Calculation of Resistance Value after High-Temperature Storage)

The cells for evaluation of the respective examples were subjected to a storage test of being left within a glove box for 3 days at 60° C. The resistance values of the cells for evaluation of the respective examples after the storage test were determined by the above-described method. The resistance values before storage, which are based on the resistance values after storage, are shown in Table 1 as relative resistance values. Further, the values of the resistance increase rate (%)=(relative resistance value after storage−relative resistance value before storage)/relative resistance value before storage×100, which were determined from the obtained relative resistance values, are shown in Table 1.

TABLE 1

| | carbon number | relative resistance | | resistance |
|---|---|---|---|---|
| | of alkyl side | value (Ω) | | increase |
| | chain of polymer | before | after | rate |
| | electrolyte | storage | storage | (%) |
| Comp. Ex. 1 | 1 | 0.52 | 1.00 | 94 |
| Comp. Ex. 2 | 2 | 0.45 | 1.00 | 121 |
| Ex. 1 | 4 | 0.73 | 1.00 | 38 |
| Ex. 2 | 6 | 1.00 | 1.00 | 0 |
| Ex. 3 | 8 | 0.81 | 1.00 | 24 |

As shown in Table 1, it can be understood that, by using the composite solid electrolytes of the Examples, an increase in resistance is suppressed as compared with the composite solid electrolytes of the Comparative Examples.

What is claimed is:

1. A composite solid electrolyte comprising:
a sulfide solid electrolyte; and
a polymer electrolyte containing a lithium imide salt and a polymer having an alkyl side chain that has 4 or more carbon atoms.

2. The composite solid electrolyte of claim 1, wherein the number of carbon atoms in the alkyl side chain of the polymer is 6 or more and 8 or less.

3. The composite solid electrolyte of claim 1, wherein a mol ratio (polymer/lithium imide salt) of the polymer with respect to the lithium imide salt is 4 or more and 7 or less.

4. The composite solid electrolyte of claim 1, wherein the polymer contains a compound expressed by the following general formula (1): 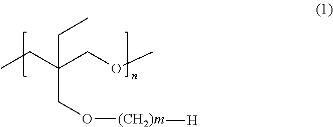
wherein, in the above general formula (1), m represents an integer of 4 or more, and n represents an integer of 1 or more.

5. A solid-state battery comprising the composite solid electrolyte of claim 1.
